(19) United States
(12) Patent Application Publication
(10) Pub. No.: US 2013/0225249 A1
(43) Pub. Date: Aug. 29, 2013

(54) FLIP ASSEMBLY AND PORTABLE ELECTRIC DEVICE COMPRISING THE SAME

(71) Applicants: Qiongyan Jiang, Shenzhen (CN); Hu Zhou, Shenzhen (CN); Xiulan Fan, Shenzhen (CN)

(72) Inventors: Qiongyan Jiang, Shenzhen (CN); Hu Zhou, Shenzhen (CN); Xiulan Fan, Shenzhen (CN)

(73) Assignee: BYD Company Limited, Shenzhen, Guangdong (CN)

(21) Appl. No.: 13/882,574

(22) PCT Filed: Nov. 10, 2011
(86) PCT No.: PCT/CN11/82047

§ 371 Date: Apr. 30, 2013

(30) Foreign Application Priority Data
Nov. 30, 2010 (CN) 201010565576.4

(51) Int. Cl. H04M 1/02

(52) U.S. Cl. CPC H04M 1/0237
USPC 455/575.3

(57) ABSTRACT

A flip assembly used to connect first and second body (11, 12) of a portable electronic device is provided. The flip assembly comprises: a sliding mechanism connected with the first body (11) and configured to slide the first body (11) relative to the second body (12); a flipping mechanism connected with the sliding mechanism and the second body (12) and configured to flip the first body (11) relative to the second body (12); a sliding control mechanism connected with the sliding mechanism and configured to control operation of the sliding mechanism so as to control the sliding of the first body (11); and a flipping control mechanism electrically connected with the flipping mechanism and configured to control operation of the flipping mechanism flip so as to control the flipping of the first body (11).

### CROSS-REFERENCE TO RELATED APPLICATIONS

This application claims priority to, and benefits under 35 U.S.C. §371 of International Patent Application No. PCT/CN2011/082047, having an international filing date of Nov. 10, 2011, which claims the benefit of Chinese Patent Application No. 201010565576.4, filed on Nov. 30, 2010. The entire contents of the above patent applications are incorporated herein by reference.

### FIELD

The present disclosure relates to an electric device, particularly related to a flip assembly of a portable electric device.

### BACKGROUND

There are mainly four kinds of portable mobile terminals, including bar phone, flip phone, slide phone, and rotate phone. The slide phones are more popular for its various advantages, such as innovative structure, convenient to operate, big screen, high resolution, smaller volume.

Conventionally, the display and keypad of the slide phone are located in the same plane when opened. The visual effect is poor when operating the slide phone, and the display will become unclear, especially in an outdoor or strong lights environment, which is inconvenient for consumers. Particularly, when the slide phone is used to display videos and used as a TV, a special support is usually needed to hold the slide phone.

However, the special support is usually very large and separated from the slide phone, which is hard to carry and very inconvenient for consumers. There is another type of slide phone having its own support, but the support is limited to use only during watching videos. Therefore, using support and operating the phone at the same time cannot be achieved. There is still another type of portable device comprising a link mechanism. The link mechanism is able to support the display and keypad at an angle when opened, but the link mechanism is semi-automatic for the user. Moreover, the display is flipping upwardly while sliding forwardly, and vibration may be caused during the slide process.

### SUMMARY

In view of this, the present disclosure solves at least one of the problems existing in the prior art. Accordingly, a flip assembly for a portable electric device is provided. By the flip assembly, the first body and second body of the portable electric device form an angle when opened, thus providing users with more convenience.

An embodiment of the present disclosure provides a flip assembly used to connect a first and a second body of a portable electronic device. The flip assembly may include: a sliding mechanism adapted to connect with the first body and configured to slide the first body relative to the second body; a flipping mechanism connected with the sliding mechanism and the second body and configured to flip the first body relative to the second body; a sliding control mechanism connected with the sliding mechanism and configured to control the sliding mechanism so as to control the sliding of the first body relative to the second body; and a flipping control mechanism electrically connected with the flipping mechanism and configured to control the flipping mechanism so as to control the flipping of the first body.

Another embodiment of the present disclosure provides a portable electronic device. The portable electronic device may comprise: a first body; a second body; and a flip assembly connected between the first and second bodies, wherein the flip assembly comprises: a sliding mechanism adapted to connect with the first body and configured to slide the first body relative to the second body; a flipping mechanism connected with the sliding mechanism and the second body and configured to flip the first body relative to the second body; a sliding control mechanism connected with the sliding mechanism and configured to control the sliding mechanism so as to control the sliding of the first body relative to the second body; and a flipping control mechanism electrically connected with the flipping mechanism and configured to control the flipping mechanism so as to control the flipping of the first body.

In an embodiment of the present disclosure, the sliding mechanism of the flip assembly may comprise: a first slide plate adapted to fix to the first body; first and second fixture blocks which are disposed at first and second ends of the first slide plate respectively in a longitudinal direction and adjacent to a first longitudinal side of the first slide plate; a second slide plate having first and second grooves at first and second ends thereof respectively, in which first and second ends of the first slide plate are received within the first and second grooves respectively and the first slide plate is slidable relative to the second slide plate along a transverse direction; third and fourth fixture blocks which are disposed at the first and second ends of the second slide plate respectively in the longitudinal direction and adjacent to a second longitudinal side of the second slide plate, in which the third fixture block has a snap notch; and first and second elastic members configured to generate elastic force driving the first slide plate to slide relative to the second slide plate, in which the first elastic member is disposed between the first fixture block and the third fixture block, and the second elastic member is disposed between the second fixture block and the fourth fixture block.

In another embodiment of the present disclosure, the sliding mechanism of the flip assembly may comprise: a first slide plate adapted to fix to the first body; a guide shaft mounted at a second end of the first slide plate and oriented in a transverse direction; a slide block mounted onto the guide shaft and slidable relative to the guide shaft in the transverse direction; a second slide plate having first and second grooves at first and second ends thereof respectively, in which first and second ends of first slide plate are received within the first and second grooves respectively and the first slide plate is slidable relative to the second slide plate along a transverse direction, the second groove is formed with a recess for receiving the slide block; an elastic member disposed between the second end of the guide shaft and the sliding block and configured to generate elastic force driving the first slide plate to slide relative to the second slide plate; and a first snap block disposed at the first end of the second slide plate, adjacent to a second longitudinal side of the second slide plate and a side of the first groove, and having a snap notch used for releasably engaging with the sliding control mechanism via snap-fit.

In still another embodiment of the present disclosure, the flipping mechanism of the flip assembly may comprise: at least one upper flip plate mounted onto the second slide plate and adjacent to a first longitudinal side of the second slide plate, the upper flip plate having a through hole extended in the longitudinal direction; a lower flip plate adapted to fix to the second body; at least one fixing shaft mounted at the first longitudinal side of the lower flip plate, in which the upper flip plate is pivotably connected to the lower flip plate by inserting the fixing shaft into the through hole; at least one torsion member fitted over the fixing shaft and configured to generate torsion force driving the upper flip plate to flip upwardly relative to the lower flip plate; and a magnetic source connected to the flipping control mechanism, mounted onto the lower flip plate and configured to generate magnetic force attracting the second slide plate to the lower flip plate.

With the portable electric device according to embodiments, the first body and the second body thereof form an angle when opened, thus improving convenience and comfortability.

### BRIEF DESCRIPTION OF THE DRAWINGS

These and other aspects and advantages of the present disclosure will become apparent and more readily appreciated from the following descriptions taken in conjunction with the drawings in which:

FIG. 1 is an exploded schematic view of a flip assembly according to an embodiment of the present disclosure;

FIG. 2 is a schematic view of a third fixture block according to an embodiment of the present disclosure;

FIG. 3 is a schematic view of a sliding mechanism according to an embodiment of the present disclosure;

FIG. 4 is a schematic view of a first torsion member according to an embodiment of the present disclosure;

FIG. 5 is an exploded schematic view of a flip assembly according to another embodiment of the present disclosure;

FIG. 6 is a schematic view of a first snap block according to an embodiment of the present disclosure;

FIG. 7 is an exploded schematic view of a portable electric device according to an embodiment of the present disclosure;

FIG. 8 is a schematic view of the portable electric device in a closed state according to an embodiment of the present disclosure;

FIG. 9 is a schematic view of the portable electric device in a sliding state according to an embodiment of the present disclosure;

FIG. 10 is a schematic view of the portable electric device in a flipping-up state according to an embodiment of the present disclosure;

FIG. 11 is an exploded schematic view of a portable electric device according to another embodiment of the present disclosure;

FIG. 12 is a schematic view of the portable electric device in a closed state according to another embodiment of the present disclosure; and

FIG. 13 is a schematic view of the portable electric device in a sliding state according to another embodiment of the present disclosure; and

FIG. 14 is a schematic view of the portable electric device in a flipping-up state according to another embodiment of the present disclosure.

### DETAILED DESCRIPTION OF THE EMBODIMENT

Reference will be made in detail to embodiments of the present disclosure. The embodiments described herein are explanatory, illustrative, and used to generally understand the present disclosure. The embodiments shall not be construed to limit the present disclosure. The same or similar elements and the elements having same or similar functions are denoted by like reference numerals throughout the descriptions.

In the description, unless specified or limited otherwise, relative terms such as “central”, “longitudinal”, “lateral”, “front”, “rear”, “right”, “left”, “inner”, “outer”, “lower”, “upper”, “horizontal”, “vertical”, “above”, “below”, “up”, “top”, “bottom” as well as derivative thereof (e.g., “horizontally”, “downwardly”, “upwardly”, etc.) should be construed to refer to the orientation as then described or as shown in the drawings under discussion. These relative terms are for convenience of description and do not require that the present disclosure be constructed or operated in a particular orientation.

Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings. In addition, terms such as “first” and “second” are used herein for purposes of description and are not intended to indicate or imply relative importance or significance.

According to embodiments of the present disclosure, a flip assembly used to connect a first body and a second body of portable electronic device is provided. The flip assembly may comprise: a sliding mechanism adapted to connect with the first body and configured to slide the first body relative to the second body; a flipping mechanism connected with the sliding mechanism and the second body and configured to flip the first body relative to the second body. Advantageously, the flipping mechanism flips the first body upwardly relative to the second body after the first body slides relative to the second body by a predetermined distance; a sliding control mechanism connected with the sliding mechanism and configured to control the sliding mechanism so as to control the sliding of the first body relative to the second body; and a flipping control mechanism electrically connected with the flipping mechanism and configured to control the flipping mechanism so as to control the flipping of the first body.

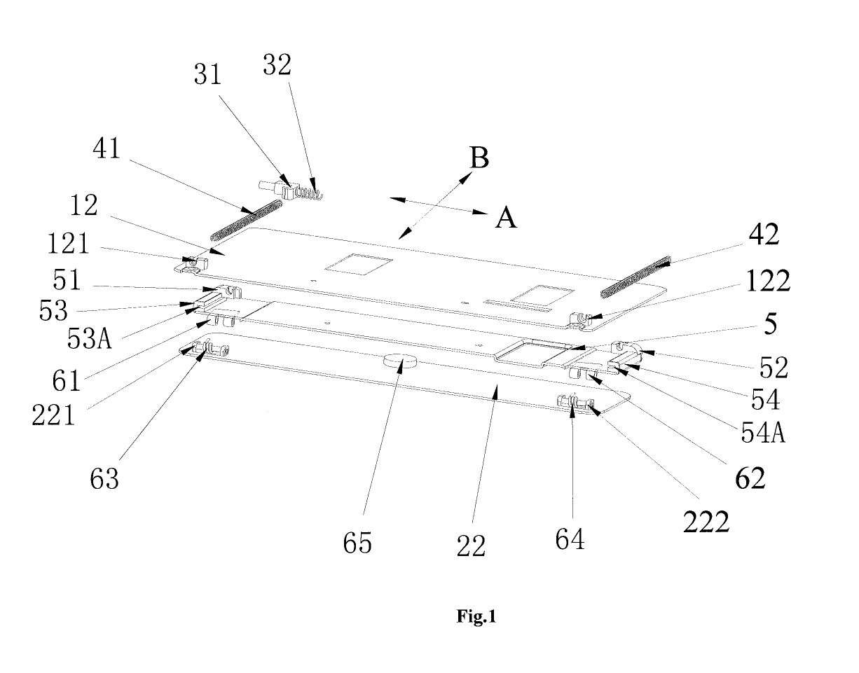

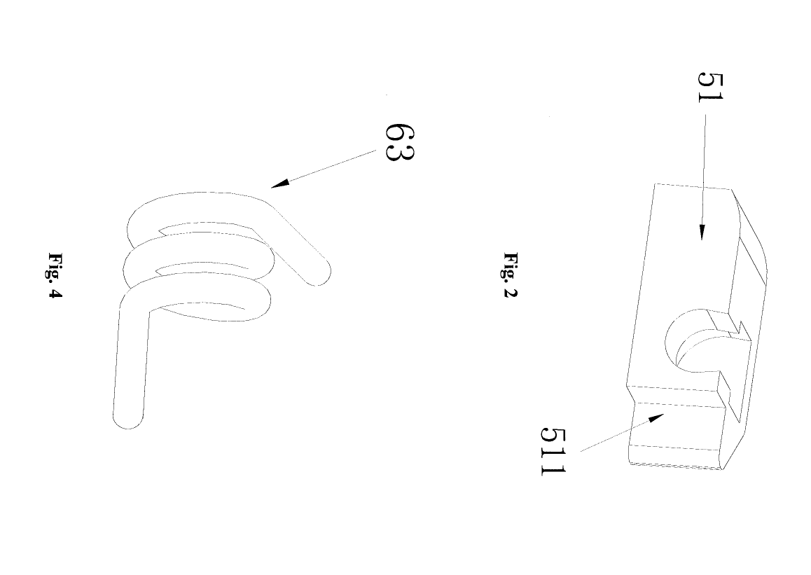

An embodiment of the flip assembly will be described with reference to FIGS. 1-4.

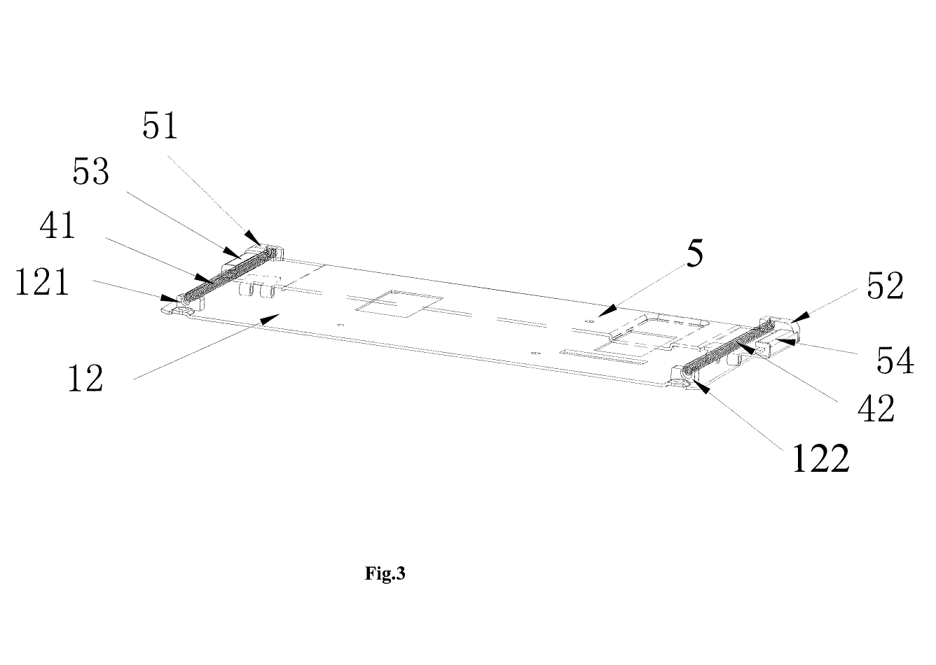

As shown in FIGS. 1 and 3, the sliding mechanism of the flip assembly comprises a first slide plate 12, a first fixture block 121 and a second fixture block 122, a second slide plate 5, a third fixture block 51, a fourth fixture block 52, first and second elastic members 41, 42.

The first slide plate 12 is to be fixed to the first body 11 of a portable electronic device.

The first fixture block 121 is disposed at the first end (the left end in FIG. 1) of the first slide plate 12 in a longitudinal direction A (the right and left direction in FIG. 1) and adjacent to the first longitudinal side (the front side in FIG. 1) of the first slide plate 12.

The second fixture block 122 is disposed at the second end (the right end in FIG. 1) of the first slide plate 12 in the longitudinal direction A and adjacent to the second longitudinal side (the rear side in FIG. 1) of the first slide plate 12.

In other words, the first fixture block 121 is disposed at the front left corner on the upper surface of the first slide plate 12 and the second fixture block 122 is disposed at the front right corner on the upper surface of the first slide plate 12 in FIG. 1.

A first groove 53A is formed at the first end (the left end in FIG. 1) of the second slide plate 5 and a second groove 54A is formed at the second end (the right end in FIG. 1) of the second slide plate 5. More particularly, a first end block 53 is disposed at first end of the second slide plate 5 and the first groove 53A is formed in the first end block 53. A second end block 54 is disposed at second end of the second slide plate 5 and the second groove 54A is formed in the second end block 54. The opening of the second groove 54A is opposed to that of the first groove 53A. The first and second end blocks 53 may be integral with the second slide plate 5. Alternatively, the first and second grooves 53A, 54A may be formed by parts of the second slide plate 5.

The first end of the first slide plate 12 is received and guided in the first groove 53A, and the second end of the first slide plate 12 is received and guided in the second groove 54A, such that the first slide plate 12 is connected with and slidable relative to the second slide plate 5 along the transverse direction B (the front and rear direction in FIG. 1) under guiding of the first groove 53A and the second groove 54A.

The third fixture block 51 is disposed at the first end (the left end in FIG. 1) and adjacent to the second longitudinal side (the rear side in FIG. 1) of the second slide plate 5. More particularly, the third fixture block 51 is cantilevered, so that a first channel is formed between the bottom surface of the third fixture block 51 and the upper surface of the second slide plate 5. The first channel is similar to the first groove 53A. Therefore, when the first slide plate 12 slides relative to the second slide plate 5, the first slide plate 12 may pass the first channel. The fourth fixture block 52 is disposed at the second end (the right end in FIG. 1) and adjacent to the second longitudinal side of the second slide plate 5. The third fixture block 51 is formed with a snap notch 511.

Similarly, the fourth fixture block 52 is cantilevered, so that a second channel is formed between the bottom surface of the fourth fixture block 52 and the upper surface of the second slide plate 5. The second channel is similar to the second groove 54A. Therefore, when the first slide plate 12 slides relative to the second slide plate 5, the first slide plate 12 may pass the second channel.

The first elastic member 41 and the second elastic member 42 are used to generate elastic force for driving the first slide plate 12 to slide relative to the second slide plate 5. The first elastic member 41 is disposed between the first fixture block 121 and the third fixture block 51, and the second elastic member 42 is disposed between the second fixture block 122 and the fourth fixture block 52. More particularly, the first end (the front end in FIG. 1) of the first elastic member 41 is connected to the first fixture block 121 and the second end (the rear end in FIG. 1) thereof is connected to the third fixture block 51, and the first end (the front end in FIG. 1) of the second elastic member 42 is connected to the second fixture block 122 and the second end (the rear end in FIG. 1) thereof is connected to the fourth fixture block 52.

In embodiments of the present disclosure, both the first and second elastic members 41, 42 are springs such as a compression spring, which generate elastic forces to slide the first slide plate 12 relative to the second slide plate 5.

In some embodiments, the flipping mechanism comprises at least one upper flip plate, a lower flip plate 22, at least one fixing shaft, at least one torsion member and a magnetic source 65.

The upper flip plate is mounted onto the second slide plate 5 and adjacent to a first longitudinal side of the second slide plate 5. The upper flip plate has a through hole extending in the longitudinal direction. The lower flip plate 22 is adapted to fix to the second body 11. The fixing shaft is mounted at the first longitudinal side of the lower flip plate 22, and the upper flip plate is pivotably connected to the lower flip plate 22 by inserting the fixing shaft into the through hole. The torsion member is fitted over the fixing shaft and used to generate torsion force driving the upper flip plate to flip upwardly relative to the lower flip plate 22. The magnetic source is connected to the flipping control mechanism, mounted onto the lower flip plate 22 and configured to generate magnetic force attracting the second slide plate 5 to the lower flip plate 22.

As shown in FIG. 1, in an exemplary embodiment, the flipping mechanism comprises a first upper flip plate 61, a second upper flip plate 62, a lower flip plate 22, a first fixing shaft 221, a second fixing shaft 222, a first torsion member 63, a second torsion member 64 and a magnetic source 65. It should be understood that the number of upper flip plate, the fixing shaft and the torsion member is not limited to two.

The first upper flip plate 61 is fixed at the first longitudinal side (the front side in FIG. 1) and adjacent to the first end of the second slide plate 5, and the second upper flip plate 62 is fixed at the first longitudinal side (the front side in FIG. 1) and adjacent to the second end of the second slide plate 5. In other words, the first upper flip plate 61 and the second upper flip plate 62 are mounted to the lower surface of the second slide plate 5, extended out from the first longitudinal side of the second slide plate 5, and spaced from each other in the longitudinal direction A. The first upper flip plate 61 is formed with a first through hole extending in the longitudinal direction A and the second upper flip plate 62 is formed with a second through hole extending in the longitudinal direction A.

The first fixing shaft 221 is mounted on the upper surface of the lower flip plate 22 and adjacent to the first longitudinal side and first end of the lower flip plate 22. The second fixing shaft 222 is mounted on the upper surface of the lower flip plate 22 and adjacent to the first longitudinal side and second end of the lower flip plate 22. The first and second upper flip plates 61, 62 are pivotably connected to the lower flip plate 22 by inserting the first and second fixing shafts 221, 222 into the first and second through holes respectively.

The first torsion member 63 is fitted over the first fixing shaft 221 and used to generate torsion force for driving the first and second upper flip plates 61, 62 to flip upwardly relative to the lower flip plate 22. Similarly, the second torsion member 64 is fitted over the second fixing shaft 222 and used to generate torsion force for driving the first and second upper flip plates 61, 62 to flip upwardly relative to the lower flip plate 22.

The second body 21 of the portable electric device may be connected with the lower flip plate 22. Therefore, the first body 11 can flip upwardly relative to the second body 21 under the torsion forces of the first and second torsion members 63, 64.

The magnetic source 65 is electrically connected to the flipping control mechanism and mounted onto the lower flip plate 22, and the magnetic source 65 is used to generate magnetic force attracting the second slide plate 5 to the lower flip plate 22 against the torsion force of the first and second torsion members 63, 64.

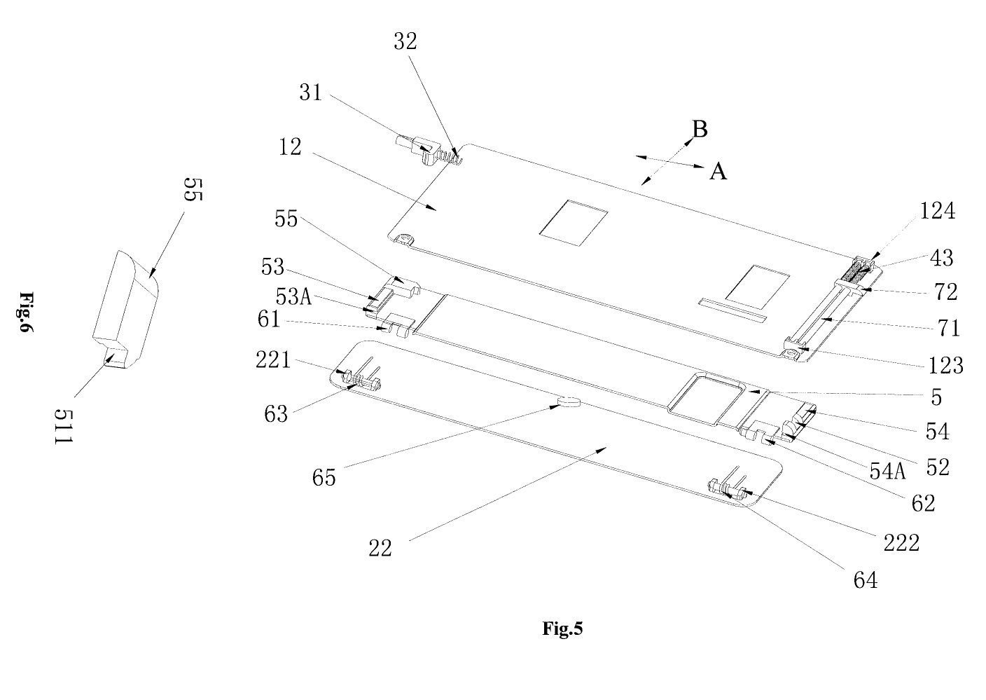

As shown in FIG. 4, in some embodiments, both the first and second torsion members 63, 64 are springs such as torsion spring. In an embodiment of the present disclosure, the magnetic source may be an electromagnet which generates magnetic force when deenergized and does not generates magnetic force when energized.

The flipping control mechanism may control the connection of the electromagnet with the power supply and disconnection of the electromagnet from the power supply. That is, the flipping control mechanism controls the energizing and deenergizing of the electromagnet. Correspondingly, the second slide plate 5 may be magnetic.

When the portable electric device is in a closed state or in a state where the first slide plate 12 starts to slide relative to the second slide plate 5, the flipping control mechanism disconnects the electromagnet from the power supply, i.e., deenergizing the electromagnet. The electromagnet on the lower flip plate 22 attracts the second slide plate 5 to the lower flip plate 22 against the torsion force of the first and second torsion members 63, 64, so that the first body 11 and second body 21 remain parallel to each other. That is, the magnetic force may counteract the torsion force of the first and second torsion members 64, 65, and the first body 11 is prevented from flip relative to the second body 21 of the portable electric device and remains parallel to the second body 21.

When the first slide plate 12 slides relative to the second slide plate 5 by a predetermined distance to a certain position, the flipping control mechanism connects the electromagnet with the power supply, i.e. energizing the electromagnet, and the electromagnet does not generate the magnetic force any more. Therefore, the torsion force of the first and second torsion members 63, 63 will flip the second slide plate 5 relative to the lower flip plate 22 upwardly. Thus the first slide plate 12 connected with the second slide plate 5 and the first body connected with the first slide plate 5, will flip upward. Therefore, an angle is formed between the first and second bodies 11, 21, thus improving convenience and comfortability of the portable electric device.

As shown in FIG. 1, in some embodiments, the sliding control mechanism comprises a second snap block 31 and a control elastic member 32.

The second snap block 31 may be mounted onto the first slide plate 12 and has an operating shaft at a first end thereof and a rod at a second end thereof. The control elastic member 32 is fitted over the rod.

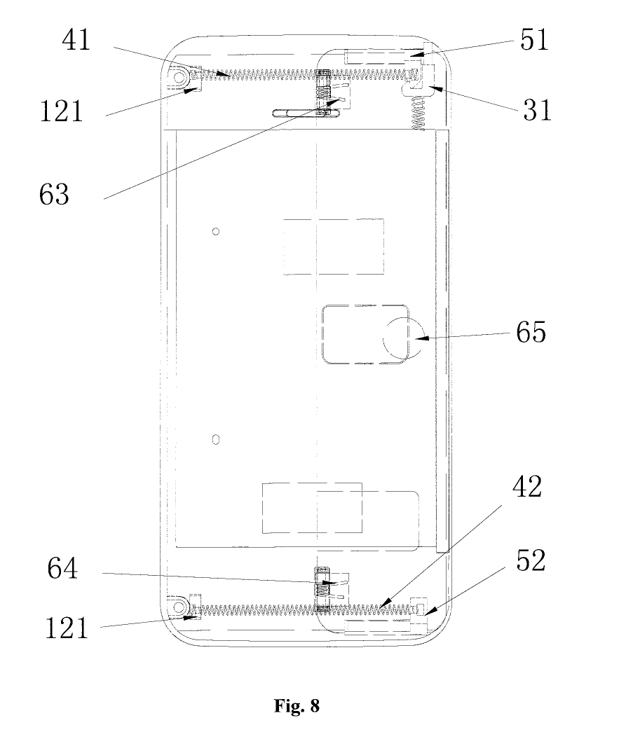

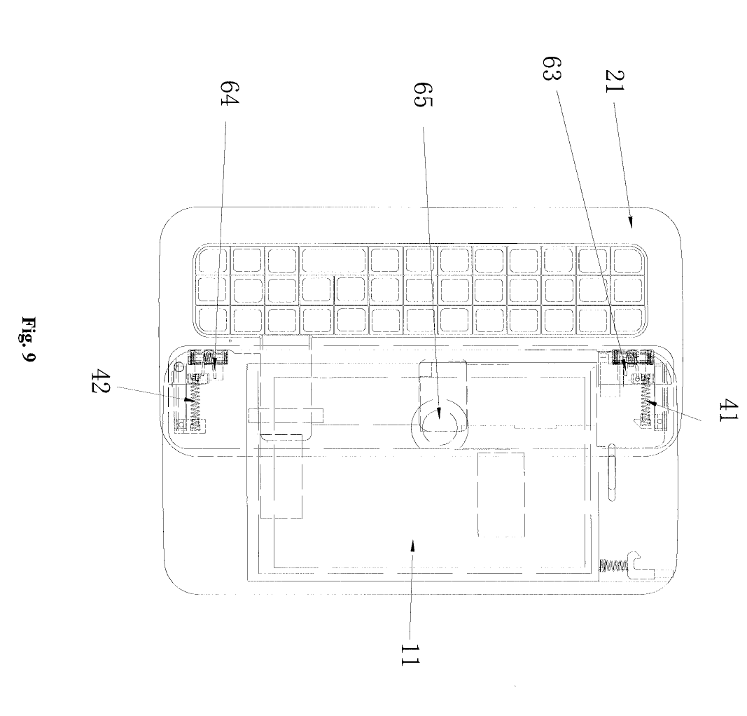

The second snap block 31 is releasably engaged with the snap notch 511 via snap-fit. More particularly, as shown in FIGS. 1 and 8, the second snap block 31 is formed with a hook portion for snapping in the snap notch 511 of the third fixture block 51.

The control elastic member 32 may be a spring normally pushing the second snap block 31 to engage with the snap notch 511 of the third fixture block 51.

The operation of the flip assembly will be described below.

When the portable electric device is in a closed state, the control shaft of the second snap block 31 is engaged with the snap notch 511 of the third fixture block 51, and the electromagnet is deenergized and generates magnetic force attracting the second slide plate 5 to the lower flip plate 22. Thus the first slide plate 12 is prevented from sliding relative to the second slide plate 5, and the first and second slide plates 12, 5 are prevented from flipping upward relative the lower flip plate 22.

To open the portable electric device, the user may press the control shaft of the second snap block 31 to disengage the second snap block 31 from the snap notch 511 of the third fixture block 51. Therefore, the first and second elastic members 41, 42 retract and generate elastic forces to slide the first slide plate 12 relative to the second slide plate 5. During the sliding of the first slide plate 12, the electromagnet is stilled deenergized and generates magnetic force attracting the second slide plate 5 to the lower flip plate 22. Thus the first and second slide plates 12, 5 are prevented from flipping upwardly relative the lower flip plate 22.

When the first slide plate 12 slides to a predetermined position in the first and second grooves 53A, 54A, the slide flipping control mechanism connects the electromagnet 65 with the power supply, so that the electromagnet 65 will not generate magnetic force. Therefore, the torsion force of the first and second torsion members 64, 65 will flip the second slide plate 5 (thereby the first slide plate 12) upwardly relative to the lower flip plate 22. In this way, the first and second bodies 11, 21 of the portable electric device form an angle therebetween.

Another embodiment of the flip assembly will be described with reference to FIGS. 5-6.

FIG. 5 is an exploded schematic view of a flip assembly according to another embodiment of the present disclosure and FIG. 6 is a schematic view of a first snap block shown in FIG. 5.

As shown in FIG. 5, the sliding mechanism comprises: a first slide plate 12, a guide shaft 71, a slide block 72, a second slide plate 5, an elastic member 43, and a first snap block 55.

The first slide plate 12 is fixed to the first body 11 of the portable electronic device.

The guide shaft 71 is mounted at the second end (right end in FIG. 5) of the first slide plate 12 and oriented in the transverse direction B. In other words, the axis of the guide shaft 71 is consistent with the transverse direction B.

The slide block 72 is mounted onto the guide shaft 71 and slidable relative to the guide shaft 71. For example, the slide block 72 is slidably fitted over the guide shaft 71.

A first groove 53A is formed at the first end (the left end in FIG. 5) of the second slide plate 5 and a second groove 54A is formed at the second end (the right end in FIG. 5) of the second slide plate 5. More particularly, a first end block 53 is disposed at first end of the second slide plate 5 and the first groove 53A is formed in the first end block 53. A second end block 54 is disposed at second end of the second slide plate 5 and the second groove 54A is formed in the second end block 54. The opening of the second groove 54A is opposed to that of the first groove 53A.

The first end of the first slide plate 12 is received and guided in the first groove 53A and the second end of the first slide plate 12 is received and guided in the second groove 54A, and the first slide plate 12 is slidable relative to the second slide plate 5 along the transverse direction B (the front and rear direction in FIG. 5) under guiding of the first groove 53A and the second groove 54A.

The second groove 54A, i.e. the second end block 54, is formed with a recess 52 for receiving and catching the slide block 72 as shown in FIG. 6.

The elastic member 43 is disposed between the second end (rear end FIG. 5) of the guide shaft 71 and the sliding block 72 and used to generate elastic force for driving the first slide plate 12 to slide relative to the second slide plate 5.

The first snap block 55 is disposed at the first end of the second slide plate 5, adjacent to the second longitudinal side of the second slide plate 5 and the rear side of the first end block 53, and has a snap notch 511 used for releasably engaging with the sliding control mechanism via snap-fit. The first snap block 55 is similar to the third fixture block 51 shown in FIG. 1. For example, the first snap block 55 is cantilevered.

In some embodiments, the guide shaft 71 comprises a first guide shaft and a second guide shaft which are disposed side by side. The slide block 72 is slidably mounted onto the first and second guide shafts.

The elastic member 43 comprises a first elastic element disposed between a second end of the first guide shaft and the slide block 72 and a second elastic element disposed between a second end of the second guide shaft and the slide block 72. The first and second elastic elements such as compression spring provide the elastic force to slide the first slide plate 12 relative to the second slide plate 5.

As shown in FIG. 5, in this embodiment, the flipping mechanism comprises a first upper flip plate 61, a second upper flip plate 62, a lower flip plate 22, a first fixing shaft 221, a second fixing shaft 222, a first torsion member 63, a second torsion member 64 and a magnetic source 65.

The first upper flip plate 61 is fixed at the first longitudinal side (the front side in FIG. 5) adjacent to the first end of the second slide plate 5, and the second upper flip plate 62 is fixed at the first longitudinal side (the front side in FIG. 5) and adjacent to the second end of the second slide plate 5. In other words, the first upper flip plate 61 and the second upper flip plate 62 are mounted to the lower surface of the second slide plate 5, extended out from the first longitudinal side of the second slide plate 5, and spaced from each other in the longitudinal direction A. The first upper flip plate 61 is formed with a first through hole extending in the longitudinal direction A and the second upper flip plate 62 is formed with a second through hole extending in the longitudinal direction A.

The first fixing shaft 221 is mounted on the upper surface of the lower flip plate 22 and adjacent to the first longitudinal side and the first end of the lower flip plate 22. The second fixing shaft 222 is mounted on the upper surface of the lower flip plate 22 and adjacent to the first longitudinal side and the second end of the lower flip plate 22. The first and second upper flip plates 61, 62 are pivotably connected to the lower flip plate 22 by inserting the first and second fixing shafts 221, 222 into the first and second through holes respectively.

The first torsion member 63 is fitted over the first fixing shaft 221 and used to generate torsion force driving the first and second upper flip plates 61, 62 (thereby the second slide plate 5 and the first slide plate 12) to flip upwardly relative to the lower flip plate 22. Similarly, the second torsion member 64 is fitted over the second fixing shaft 222 and configured to generate torsion force driving the first and second upper flip plates 61, 62 (thereby the second slide plate 5 and the first slide plate 12) to flip upwardly relative to the lower flip plate 22.

The second body 21 of the portable electric device may be connected with the lower flip plate 22. Therefore, the first body 11 can flip upwardly relative to the second body 21 under the torsion forces of the first torsion member 63 and the second torsion member 64.

The magnetic source 65 is electrically connected to the flipping control mechanism and mounted onto the lower flip plate 22. The magnetic source 65 is used to generate magnetic force attracting the second slide plate 5 to the lower flip plate 22 against the torsion force of the first and second torsion members 63, 64.

In some embodiments, both the first and second torsion members 63, 64 are springs such as torsion spring. In an embodiment of the present disclosure, the magnetic source may be an electromagnet.

The flipping control mechanism may control the connection of the electromagnet with the power supply and disconnection of the electromagnet from the power supply. Correspondingly, the second slide plate 5 may be magnetic.

When the portable electric device is in a closed state or in a state of the first slide plate 12 sliding relative to the second slide plate 5, the flipping control mechanism disconnects the electromagnet from the power supply, the electromagnet on the lower flip plate 22 attracts the second slide plate 5 to the lower flip plate 22 against the torsion force of the first and second torsion members 63, 64, so that the first body 11 and second body 21 are parallel to each other. That is, the magnetic force may balance the torsion force of the first and second torsion members 64, 65, and the first body 11 is prevented from flipping relative to the second body 21 of the portable electric device.

When the first slide plate 12 slides relative to the second slide plate 5 by a predetermined distance to a certain position, the flipping control mechanism connects the electromagnet with the power supply, and the electromagnet does not generate the magnetic force any more. Therefore, the torsion force of the first and second torsion members 63, 63 flip the second slide plate 5 (thereby the first slide plate 12 connected with the second slide plate 5 and the first body connected with the first slide plate 5) upwardly relative to the lower flip plate 22. Therefore, an angle is formed between the first and second bodies 11, 21, thus improving convenience and comfortability of the portable electric device.

As shown in FIG. 5, in some embodiments, the sliding control mechanism comprises a second snap block 31 and a control elastic member 32.

The second snap block 31 may be mounted onto the first slide plate 12, have an operating shaft at a first end thereof and a rod at a second end thereof, and the control elastic member 32 is fitted over the rod.

The second snap block 31 is releasably engaged with the snap notch 511 via snap-fit. More particularly, as shown in FIG. 5, the second snap block 31 is formed with a hook portion for snapping in the snap notch 511 of the first snap block 55.

The control elastic member 32 may be a spring normally pushing the snap block 31 to engage with the snap notch 511 of the first snap block 55.

The operation of the flip assembly according to this embodiment will be described below.

When the portable electric device is in closed state, the control shaft of the second snap block 31 is engaged with the snap notch 511 of the first snap block 55, and the electromagnet is deenergized and generates magnetic force attracting the second slide plate 5 to the lower flip plate 22, thus the first slide plate 12 is prevented from sliding relative to the second slide plate 5, and the first and second slide plates 12, 5 are prevented from flipping upwardly relative the lower flip plate 22.

To open the portable electric device, the user may press the control shaft of the snap block 31 to disengage the snap block 31 from the snap notch 511 of the first snap block 55. Therefore, the first and second elastic elements are extended and provide elastic forces to slide the first slide plate 12 relative to the second slide plate 5. During the sliding of the first slide plate 12, the electromagnet is stilled de-energized and generates magnetic force attracting the second slide plate 5 to the lower flip plate 22, thus the first and second slide plates 12, 5 are prevented from flipping upwardly relative the lower flip plate 22.

When the first slide plate 12 slides to a predetermined position, the slide flipping control mechanism connects the electromagnet 65 with the power supply, so that the electromagnet 65 will not generate magnetic force. Therefore, the torsion force of the first and second torsion members 64, 65 will flip the second slide plate 5 upwardly relative to the lower flip plate 22. In this way, the first and second bodies 11, 21 of the portable electric device form an angle therebetween.

The portable electric device according to embodiments of the present disclosure is described below.

The portable device of the embodiments may comprise a first body, a second body, and a flip assembly connected between the first and second bodies.

The flip assembly comprises: a sliding mechanism adapted to connect with the first body and configured to slide the first body relative to the second body; a flipping mechanism connected with the sliding mechanism and the second body and configured to flip the first body relative to the second body; a sliding control mechanism connected with the sliding mechanism and configured to control operation of the sliding mechanism so as to control the sliding of the first body relative to the second body; and a flipping control mechanism electrically connected with the flipping mechanism and configured to control operation of the flipping mechanism so as to control the flipping of the first body.

In an embodiment of the present disclosure, a display is disposed on the first body, and a keypad is disposed on the second body.

The flip assembly may be any of the aforementioned flip assemblies described with reference to FIGS. 1-6.

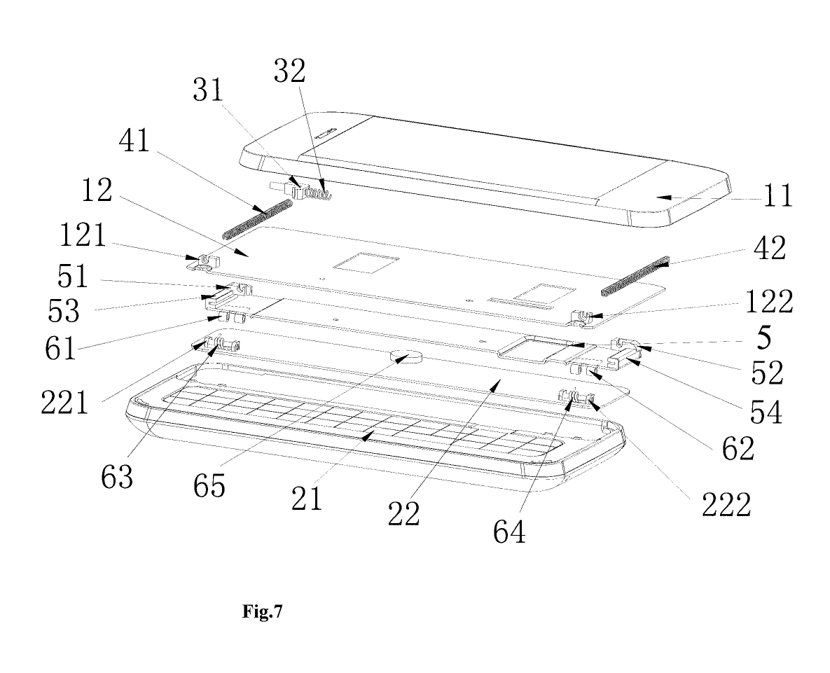

As shown in FIG. 7, the portable electric device according to an embodiment of the present disclosure has a flip assembly as shown in FIG. 1. A first body 11 is fixed with the first slide plate 12, and a second body 21 is fixed with the lower flip plate 22.

FIG. 8 shows the portable electric device in an assembled and closed state. The first end of the first elastic member 41 is connected with the first fixture block 121 and the second end thereof is connected with the third fixture block 51.

The first end of the second elastic member 42 is connected with the second fixture block 122 and the second end thereof is connected with the fourth fixture block 52.

The second snap block 31 is engaged in the snap notch 511 of the third fixture block 51. The magnetic source 65 is de-energized and generates a magnetic force to attract the second slide plate 5 to the lower flip plate 22. The magnetic force balances the torsion force of the first and second torsion members 63, 64. Therefore, the first body 11 is prevented from sliding and flipping relative to the second body 21.

To open the portable electric device, the user presses the operative shaft of the sliding control mechanism, and the second snap block 31 is disengaged from the snap notch 511 of the third fixture block 51.

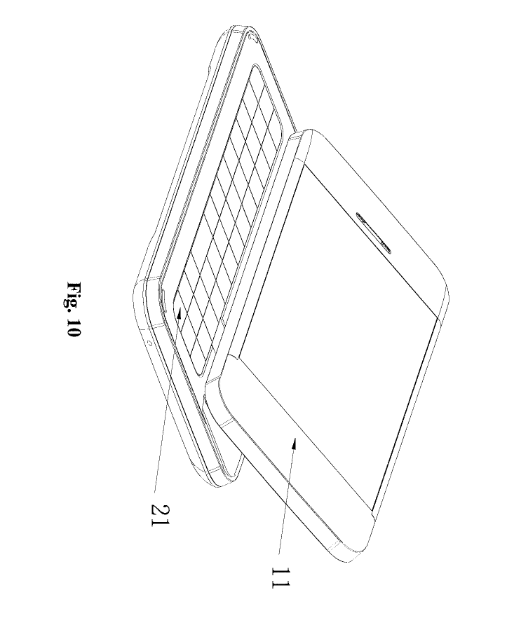

Then the first and second elastic members 41, 42 retract and slide the first body 11 relative to the second body 21 in the transverse direction B (the right and left direction in FIG. 8) to the position shown in FIG. 9.

At the position shown in FIG. 9, the magnetic source 65 is not energized and provides the magnetic force attracting the second slide plate 5 to the lower flip plate 22 against the torsion force of the first and second torsion members 63, 64, that is, the magnetic force may balance the torsion force of the first and second torsion members 63, 64, so that the first body 11 is prevented from flipping relative to the second body 12.

When the first body 11 slides relative to the second body 21 from the position shown in FIG. 9 to a certain position, the flipping control mechanism connects the magnetic source with the power supply. Thus, the magnetic source does not generate the magnetic force, so that the torsion force of the first and second torsion members 63, 64 flip the first body 11 upwardly relative to the second body 22, and an angle is formed between the first and second bodies 11, 21, shown in FIG. 10. In this way, the display on the first body 11 is at the angle relative to the keypad on the second body 21, thus improving the comfortability and convenience of the portable electronic device.

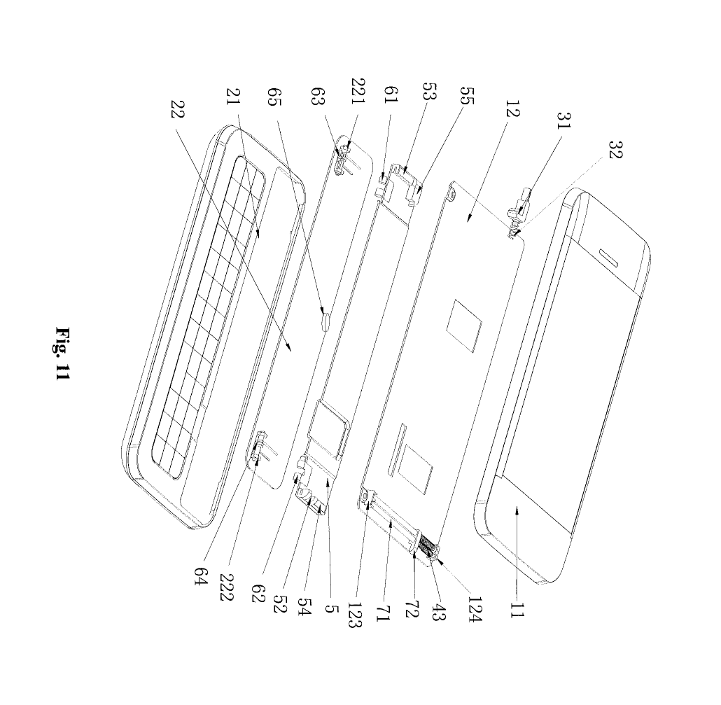

FIG. 11 shows an exploded view of a portable electric device having a flip assembly shown in FIG. 5. The first body 11 is fixed with the first slide plate 12, and the second body 21 is fixed with the second slide plate 22.

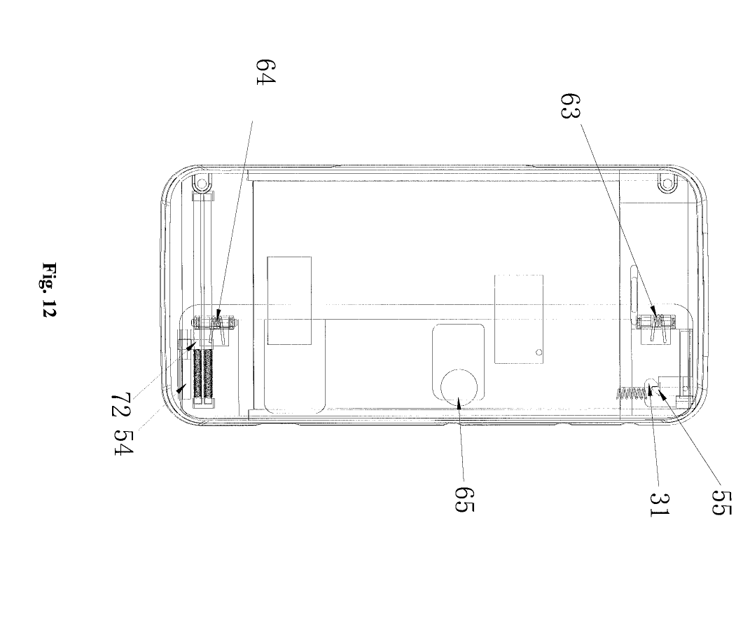

FIG. 12 shows the portable electric device of FIG. 12 in an assembled and closed state. In FIG. 12, the slide block 72 is received and caught in the recess of the second groove 54A (i.e. the second end block 54), thus preventing the first and second elastic elements from stretching.

The second snap block 31 is engaged with the snap notch 511 of the first snap block 55, so that the first body 11 is prevented from sliding relative to the second body 21. The electromagnet 65 is de-energized and generates a magnetic force attracting the second slide plate 5 to the lower flip plate 22. In other words, the magnetic force may balance the torsion force of the first and second torsion members 63, 64. Therefore, the first body 11 is prevented from sliding and flipping relative to the second body 12.

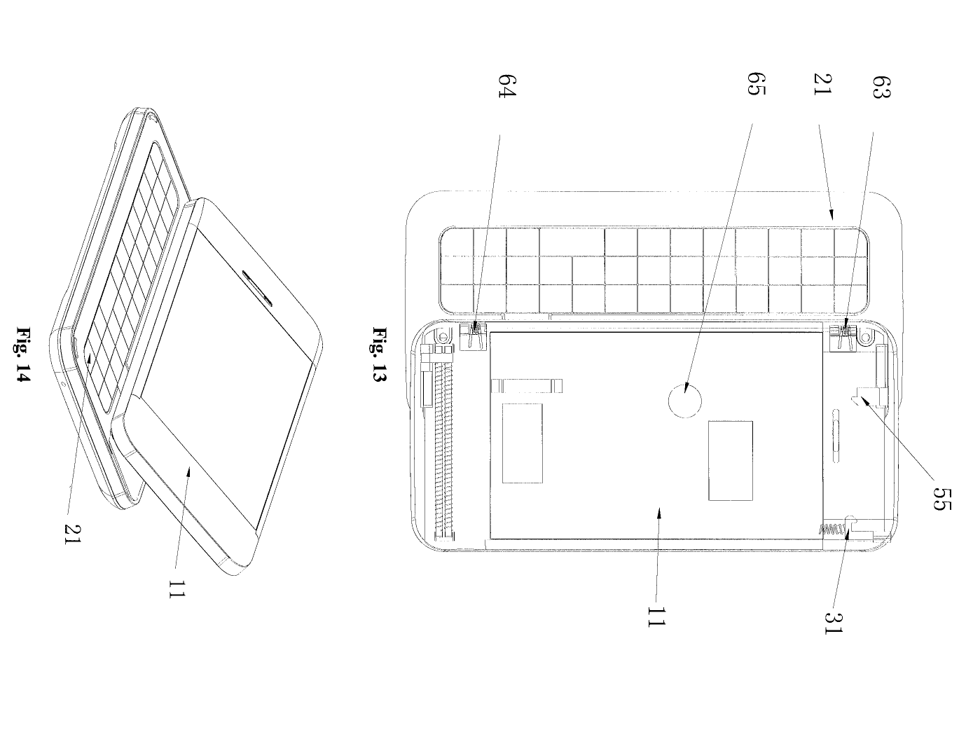

To open the portable electric device, the user presses the operative shaft of the flipping control mechanism, and thus the second snap block 31 is disengaged from the snap notch 511 of the first snap block 55. Thus, the first and second elastic elements stretch and provide elastic forces to slide the first body 11 relative to the second body 21 in the transverse direction B (the right and left direction in FIGS. 12 and 13) to the position shown in FIG. 13.

At the position shown in FIG. 13, the magnetic source 65 is still deenergized and generates a magnetic force to attracting the second slide plate 5 to the lower flip plate 22. The magnetic force may balance the torsion force of the first and second torsion members 63, 64, thus the first body 11 is prevented from flipping relative to the second body 21.

When the first body 11 keeps on sliding from the position shown in FIG. 13 to a certain position, that is, the first body 11 slides by a predetermined distance from the position shown in FIG. 13 rightwards, the flipping control mechanism connects the magnetic source from the power supply. Thus, the magnetic source does not generate the magnetic force, and the first and second torsion members flip the first body 11 upwardly relative to the second body 21, so that the first and second bodies 11, 21 forms an angle, as shown in FIG. 14. Therefore, the display on the first body 11 is at the angle relative to the keypad on the second body 21, thus improving comfortability and convenience.

With the portable electric device according to embodiments of the present disclosure, the display on the first body 11 and the keypad on the second body 21 may form an angle when the portable electric device is opened. The angle not only improves convenience and comfortability, but also overcomes the disadvantage of view effects.

In addition, the flip assembly may be configured to be a part of the portable electric device, which is able to slide and then flip the first body relative to the second body automatically. The sliding and flipping process is smooth. Moreover, the sliding and flipping process may be initiated by only press the operating shaft once. And the portable electric device is convenient for carrying and storage.

Although explanatory embodiments have been shown and described, it would be appreciated by those skilled in the art that changes, alternatives, and modifications all falling into the scope of the claims and their equivalents may be made in the embodiments without departing from spirit and principles of the present disclosure.

1-15. (canceled)

16. A flip assembly for a portable electronic device having a first body and a second body, the flip assembly comprising:
a sliding mechanism that slidably connects the first body to the second body; and
a flipping mechanism that pivotably connects the first body to the second body,
wherein the flipping mechanism pivots the first body away from the second body after the first body is slidably moved to a predetermined position relative to the second body.

17. The flip assembly according to claim 16, wherein the sliding mechanism comprises a first slide plate attached to the first body, and a second slide plate pivotably connected to the second body, the first slide plate being slidable relative to the second slide plate.

18. The flip assembly according to claim 17, wherein the flip mechanism comprises a lower flip plate attached to the second body and disposed between the second slide plate and the second body, the second slide plate being pivotable relative to the lower flip plate.

19. The flip assembly according to claim 18, further comprising a magnetic source that controls operation of the flipping mechanism.

20. The flip assembly according to claim 19, wherein the flipping mechanism further comprises at least one torsion member that provides a torsion force to flip the second slide plate upward relative to the lower flip plate.

21. The flip assembly according to claim 19, wherein when the magnetic source is deenergized, the magnetic source applied a magnetic force to the second slide plate to attract the second slide plate to the lower flip plate against the torsion force, and when the magnetic source is energized, no magnetic force is applied to the second slide plate and the torsion force of the at least one torsion member flips the second slide plate upward relative to the lower flip plate.

22. The flip assembly according to claim 19, wherein the magnetic source is connected to a power source and selectively energized depending on a position of the first slide plate.

23. The flip assembly according to claim 18, wherein the second slide plate defines grooves for guiding a sliding movement of the first slide plate.

24. The flip assembly according to claim 17, wherein the second slide plate is pivotable around a first longitudinal side of the lower flip plate after the first slide plate slides to the predetermined distance toward a second longitudinal side of the lower flip plate opposing the first longitudinal side.

25. The flip assembly according to claim 17, further comprising at least one spring that causes the first slide plate to slide relative to the second slide plate.

26. The flip assembly according to claim 25, further comprising a snap block operable to release the at least one spring, when the at least one spring is released, the first slide plate is pushed by the at least one spring to slide relative to the second slide plate.

27. A flip assembly for a portable electronic device having a first body and a second body, the flip assembly comprising:
a first slide plate attached to the first body;
a second slide plate slidably connected to the first slide plate;
a lower flip plate attached to the second body;
a torsion spring that pivotably connects the second slide plate to the lower flip plate and that provides a torsion force to pivot the second slide plate away from the lower flip plate; and
a magnetic source selectively attracting the second slide plate to the lower flip plate against the torsion force;
wherein when the magnetic source is deenergized, the magnetic source provides a magnetic force to attract the second slide plate to the lower flip plate against the torsion force and when the magnetic source is deenergized, the torsion force flips the second slide plate upward relative to the lower flip plate to define an angle.

28. The flip assembly according to claim 27, wherein the magnetic force is energized when the first slide plate slides to a predetermined position relative to the second slide plate.

29. The flip assembly according to claim 27, wherein the magnetic force is electrically connected to a power source that energizes the magnetic force.

30. A portable electronic device comprising:
a first body;
a second body slidably and pivotably connected to the first body;
a sliding mechanism slidably connecting the first body to the second body; and
a flipping mechanism pivotably connecting the first body to the second body,
wherein the flipping mechanism pivots the first body away from the second body after the first body is slidably moved to a predetermined position.

31. The portable electronic device according to claim 30, further comprising a magnetic source that controls the operation of the flipping mechanism.

32. The portable electronic device according to claim 30, wherein the sliding mechanism includes a first slide plate attached to the first body, and a second slide plate disposed between the first slide plate and the second body, the first slide plate being slidable relative to the second slide plate, and wherein the flipping mechanism includes a lower flip plate attached to the second body and a torsion member pivotably connecting the second slide plate to the lower flip plate.

33. The portable electronic device according to claim 32, further comprising a magnetic source that provides a magnetic force to attract the second slide plate to the lower flip plate against a torsion force of the torsion member when the magnetic source is deenergized.

34. The portable electronic device according to claim 33, wherein the torsion member flips the second slide plate upward relative to the lower flip plate when the magnetic source is energized and no magnetic force is applied to the second slide plate.

35. The portable electronic device according to claim 30, wherein the sliding mechanism comprises at least one compression spring, when the compression spring is released, the first body is slidable relative to the second body.
